(19) United States
(12) Patent Application Publication
(10) Pub. No.: US 2015/0101196 A1
(43) Pub. Date: Apr. 16, 2015

(54) V SHAPED SAFETY RAZOR

(71) Applicant: Santiago Bolivar, Cali, CO (US)

(72) Inventor: Santiago Bolivar, Cali, CO (US)

(21) Appl. No.: 14/054,832

(22) Filed: Oct. 16, 2013

(51) Int. Cl. B26B 21/06

(52) U.S. Cl. CPC B26B 21/06
USPC 30/50

(57) ABSTRACT

An efficient and soft safety razor unit is provided including at least one blade with a sharp cutting edge extending lengthwise of the blade unit, built in an inverted “V” shape, in the first embodiment, or in a “V” shape, in another embodiment, the support structure has the same shape, so that, at shaving time, the blade or blade cut every single hair of the beard (or another part of the body, for example legs, or chest, etc.) with an angle corresponding to the angle in which the “V” has been built, producing or achieving a more efficient and softer beard cut, due to the “guillotine” effect on each beard hair produced by the inclined blades.

This safety razor unit may have one or more blades (two, three, four, etc.) all of them made in an inverted “V” shape, or in the normal “V” shape and with the vortex rounded, so that the probability of skin injury is reduced to a minimum.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING

Not applicable.

### BACKGROUND

### Prior Art

This razor relates to safety razors of the kind in which a blade unit assembly is carried by a handle and includes at least one blade member with a cutting edge which is moved across the surface of the skin being shaved, by means of the handle.

A blade unit may be mounted detachable on a razor handle to enable the blade unit to be replaced by a fresh blade unit when the blade sharpness has diminished to an unsatisfactory level, or it may fixedly attached to the handle so that the entire razor can be discarded when the blade or blades have become dulled. Detachable and replaceable blade units are commonly referred to as shaving cartridges. Alternatively, a blade unit may be attached permanently to the handle with the intention that the entire razor should be discarded when the blade or blades have become dulled.

Despite the shaving cartridge is detachable or replaceable, it can be mounted on the handle by any well-known method so that it can be capable of having a pivoting movement, or it can be mounted fixed to the handle.

As mentioned above the present razor relates to safety razors with blade units arranged to be capable of pivoting movement relative to the handles, on which the blade units are carried, in the course of shaving. The pivoting motion allows the blade unit to follow more easily the skin contours so that the exact angle at which the handle is held relative to the skin is less critical to achieving a good shaving performance and efficiency. Razors with pivotal blade units have been successfully marketed for many years. The pivot axis, which usually extends parallel to the cutting edges of the blades, can be defined by a pivot structure by means of which the handle is connected to the blade unit. Alternatively the blade unit may include an attachment member to which a frame or housing incorporating the blade or blades and other skin contacting parts, is pivotally connected.

Various positions of the pivot axis relative to the blade edges have been proposed and used, including positions above and below a plane tangential to the guard and cap surfaces, and positions in front of, behind and in the region of the blade edges. There is generally a rest position to which the pivotal blade unit is biased by a spring-like arrangement and many different forms of mechanical spring-like arrangement have been suggested and implemented in the prior art.

The difference between this safety razor and the previous safety razors commonly used and sold in the marketplace, is that the blade assembly is built in an inverted V shape, (in one of the embodiments), taking in account that the normal position of the “V” letter is “V”, with the vortex in the bottom and the ends of the “arms” in the top, instead of the common shape (horizontal and plane) usually used in this kind of devices, so that when the blade or blades get in contact with the beard hair, at shaving time, there will be a cutting relative movement (or displacement) between the blade or blades and the beard hairs, additional to the normal movement of the handle, and parallel to the skin, (as usually happens in a common safety razor), allowing a softer and more efficient shaving.

A good comparison would be with the sadly famous guillotine proposed (but not invented by him) by French doctor Dr. Joseph Ignace Guillotin, in France in the 17^{th} century, for executing people and in which the cutting edge of the blade was not horizontal, but oblique, so it had an angle in relation with the horizontal line in order to make a better neck cut. In fact, they had many problems with the first models of the guillotine, due to the cutting edge was horizontal, and the tests conducted in dead bodies were not successful.

This new safety razor cuts the beard hair in a similar way, and not like the common razors used today which cut the beard hairs in a flat or 0 or 180 degree angle, meaning horizontal, relative to the face skin and the beard hair, making the shaving process a little rough. Additionally, the razors commonly used presently, produce a pulling effect on every beard hair they cut, and not a plain cutting effect, due to the horizontal position between beard hair and cutting edges.

Instead of the horizontal contact with the beard hairs, meaning that the cutting edge of the blade or blades contact the beard hairs at 0 or 180 degree angle, this safety razor locates the blade or blades in such a way that the cut will be doing always in a certain angle between the blade or blades and the beard hairs to make shaving easier, softer and more efficient and comfortable than with conventional razors. This could be compared with the ways of cutting with a regular knife: one way is by pushing the knife vertically on the product being cutting towards the cutting surface, and the other way is by doing two movements simultaneously, the same vertical movement and at the same time, moving the knife horizontally and parallel or obliquely to the cutting surface, back and forth, so the product is cut in a much more easier way.

Besides that, due to this cutting method, the blade or blades should last longer without necessity of replacement, because of the better possible use of the cutting edges.

Razor blades units generally include guard and cap surfaces for respectively contacting the skin in front of and behind the blades; these surfaces serving important roles in establishing the so-called shaving geometry, i.e. the parameters which determine the blade orientation and position relative to the skin during shaving.

There have been prior proposals to equip a safety razor with a comb-like structure for contacting the skin in front of a blade edge, such structure is in some cases arranged on or to constitute the guard surface, while other arrangements have inclusion of the comb structure in a spacer between a pair of tandem blades. The comb structures are provided with a view to achieving a balance between safety and comfort on one hand, and closeness of shave on the other hand. Examples of prior art comb structures are described in U.S. Pat. Nos. 3,004,337, 4,272,885 and 5,359,774, in which it is explained that improved safety and comfort come from reduced contact between the skin and the blade edge.

### SUMMARY

The present safety razor has for its object to improve shaving process by using one or more blades mounted in an inverted V-Shaped unit or cartridge so that the contact of such a blade or blades with the beard hairs at cutting time, is oblique, in an angle different from 0 or 180 degrees, instead of being with no angle at all, meaning 0 or 180 degrees. This means that at shaving time, each beard hair is being cut with a slight knife-like movement of the blade that could be called “guillotine effect”, because the guillotine blade was built in such a way that its contact was in a relative angle between the blade itself and the position of the neck of the convicted, producing a more efficient, effective and softer cutting action.

One form of efficient and soft razor blade unit according to the safety razor comprises one blade assembly with an inverted “V” shape, with at least one sharp cutting edge, or a plurality of cutting edges. This can be done by making at least one standalone inverted V-Shaped blade or several inverted V-Shaped blades located in a parallel form between each blade, getting all of them an inverted “V” shape. This means that each cutting blade Although the blade units of the safety razor may have one single blade, a plurality of blades, e.g. 2, 3, 4, or more blades, are preferably included and extended continuously has an inverted “V” shape.

The details of one or more embodiments of the safety razor are set forth in the accompanying drawings and the description below. Other features, objects and more advantages of the safety razor will be apparent from the description and drawings, and from the claims.

### ADVANTAGES

This way of cutting results in a more rapid, efficient and softer action, so the one who is shaving will feel more comfortable with the razor, because the shaving will be better and softer than with conventional safety razors.

Additionally, due to the inverted V-shaped blade assembly, the risk of a parallel movement of the razor to the blade or blades (this is movement along the horizontal formed by the blades in the conventional safety razors, instead of the vertical movement produced at shaving time), is reduced greatly, reducing, at the same time, the risk of skin injure.

### BRIEF DESCRIPTION OF THE SEVERAL VIEWS OF THE DRAWING

FIG. 1 is a general view of the safety razor blade unit.

FIG. 2 shows basically the same razor in a front view, excepting that the blade assembly is made not in an inverted V shape, but exactly in the opposite way that in the embodiment shown in FIG. 1.

FIG. 3 shows the way the beard hair is cut with the conventional blades in horizontal assembly and in vertical movement.

FIG. 4 shows the way the beard hair is cut with the V-shaped blades.

### DETAILED DESCRIPTION

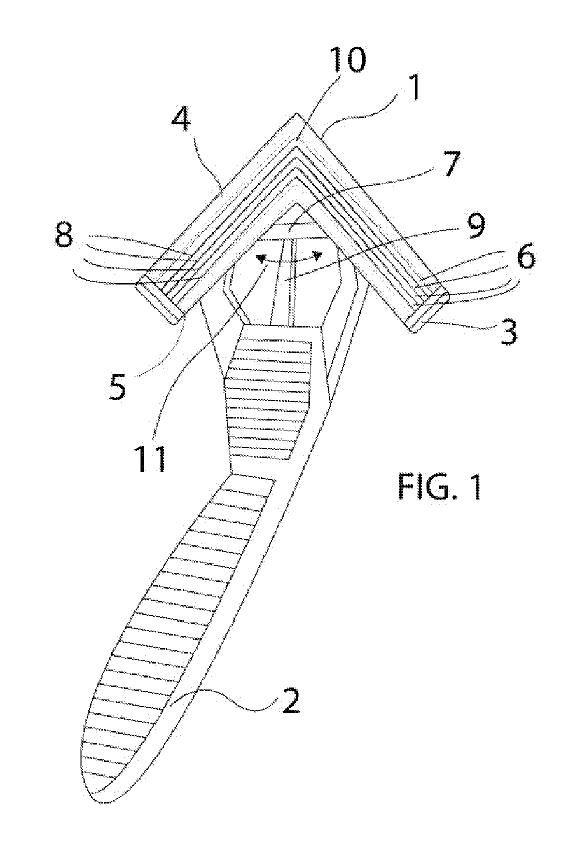

The razor illustrated in FIG. 1 has a blade assembly 1 mounted on a handle 2. The blade assembly includes a frame 3 with a guard 4 and a cap 5 and a plurality of blades 6 positioned between the guard and the cap with their cutting edges 8 parallel to each other, as well known in the art. The guard preferably includes a strip of elastomeric material with projections such as fins, and the cap may comprise a strip for applying a shaving enhancement product for the skin as previously known.

In FIG. 1 are also shown other parts of the embodiment as follows:

A fixing bar 7 gives support to a spring-like support bar 9 to facilitate the movement of the blade assembly when using living hinges or any kind, as well known in the prior art.

Also is shown a rounded vortex 10 in each blade mounted on the blade assembly, and an angle 11 between the two parts of the inverted V blade assembly.

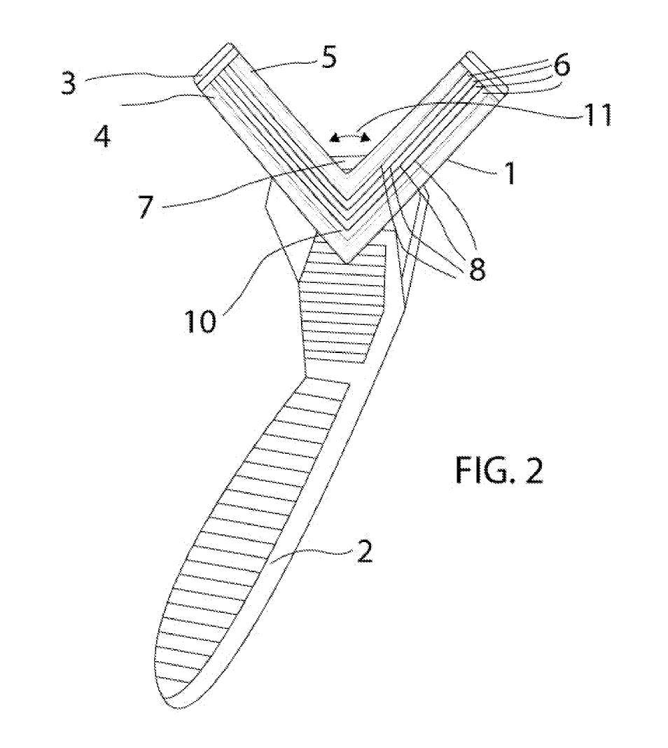

FIG. 2 shows another embodiment for this safety razor, which is similar to the previous one, but with the blade assembly made in opposite way, this is, with the “V” not in inverted shape, but in the normal way, as the letter “V” is usually written. The difference between the two embodiments is the position of the “V”, and the cutting edges which are located in opposite way.

As shown in FIG. 1, the blades does not have a straight shape, but they are made in such way that there is an angle conforming an inverted “V” letter, and giving to the blades their special shape.

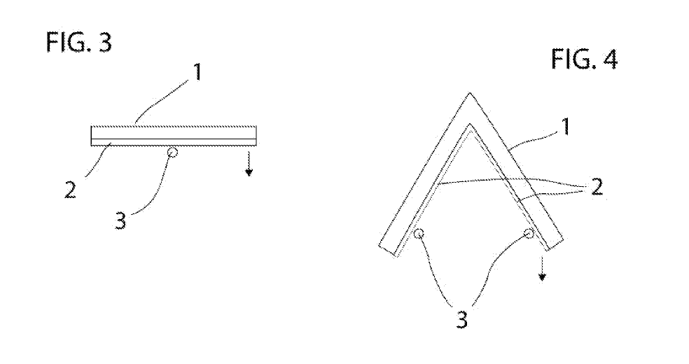

As shown in FIG. 3, this is a view of the way in which a beard hair is cut using a horizontal blade, and it can be seen that could there be a lateral movement of the blade, with a risk of injury the skin.

FIG. 4 shows an individual blade, and the way the beard hair would be cut by the V shaped blade. In this figure it can be seen that the inverted “V” blade assembly cannot move in horizontal way, so it is very hard to injury the skin in this way.

The first way to make it is by making each blade in an inverted “V” shape, with the cutting edges on the internal sides of the blade, and a rounded shape in the vortex of the “V”, as it can be seen in FIG. 1, and with the cutting edges as shown in FIG. 4.

A second way to make it is by making each blade in a “V” shape, not inverted, with the cutting edges on the external sides of the blade, and a rounded shape in the external vortex of the blades for avoiding injury risk, as can be seen in FIG. 2.

At present, I believe that the first embodiment operates most efficiently, but the other embodiment is also satisfactory.

The safety razor shown in FIG. 2 differs from that in FIG. 1 in the geometric form of the blade assembly, because in this alternative embodiment, such assembly is built in opposite direction, meaning that the “V” shaped assembly has been made not inverted like in the first embodiment, but in “normal” position of the “V”. By doing this, the guillotine effect is the same as in the first case, so either two models could be made for general use. The cutting edges in this case are located on the external sides of the blades, as shown in FIG. 2.

In another embodiment, the inverted V-shaped safety razor, could be made in such a way that the two parts of the “V” are not fixed, meaning that these two parts might be change the angle in between these two parts. This could be done by attaching two conventional cutting blades by one end, forming an inverted “V”, and allowing the two blades to change its relative position by using an axis located in the end that connects the blades. In this embodiment, the safety razor should be made in such a way that the two parts of the “V” can be move as if they had an axis located in the “V” vortex so that the “V” can be closed or opened to change between the two parts forming the V-like shape, so the angle between the two parts of the “V”, can be changed by opening or closing the two parts of the “V”.

### TECHNICAL FIELD

This invention relates to safety razors, and it is related particularly with safety razors in which a safety razor blade unit including at least one blade with a sharp cutting edge is mounted on a razor to be movable pivotally relative to the handle under forces exerted on the blade unit in the course of shaving. In this case, as expressed before, the blade or blades has or have an inverted “V” shape, as shown in the several drawings. The safety razor can be made also with the blade assembly fixed to the handle.

A blade unit may have one single blade, or plurality blades, could be two, three, four or more blades with straight parallel cutting edges disposed for contact with the skin between guard and cap surfaces, also provided on the blade unit, the guard may include a strip of elastomeric material with a surface configuration, to produce a desired interaction with the skin as the blade unit is moved across the skin in the performance of a shaving stroke.

The cap surface may include a strip of material containing a shaving enhancement product, such as a lubricant, which can gradually leach out of the strip material for application to the skin during shaving.

What is claimed is:

1. A safety razor blade unit comprising a blade assembly with at least one blade made in an inverted “V” shape, in one of the embodiments, with a sharp cutting edge extending lengthwise of the inverted V-shaped blade unit, or built in a “V” shape (not inverted) in another embodiment, and a handle; the blade or blades being carried by a blade assembly in pivotally joined, or fixed to the handle.

2. A safety razor blade unit according to claim 1, wherein the blade assembly has an inverted “V” shape with the blade or blades of said assembly made each one of them in an angled way, creating the inverted “V” shape.

3. A safety razor blade unit according to claim 1 wherein at least a portion of the blade assembly is connected to a portion of the handle by one or several living or fixed hinges.

4. A safety razor blade unit according with claim 1 wherein the blade or blades have an inverted “V” shape and a rounded vortex of the “V” in order to make a softer cutting movement with the beard hairs at shaving time.

5. A safety razor blade unit according with claim 1 wherein the blade or blades are located in the same plane, so that the blade or blades make contact with the skin in the same plane and in the same way at shaving time.
